(19) United States
(12) Patent Application Publication
(10) Pub. No.: US 2023/0024740 A1
(43) Pub. Date: Jan. 26, 2023

(54) BATTERY MODULE

(71) Applicants: Hyundai Motor Company, Seoul (KR); Kia Corporation, Seoul (KR)

(72) Inventors: Yu Ri Oh, Hwaseong-si (KR); Woo Young Choi, Anyang-si (KR); Ji Woong Jung, Anyang-si (KR); Gyung Hoon Shin, Seoul (KR); Ju Hyeok Park, Incheon (KR); Woo Chan Lee, Hwaseong-si (KR); Hae Kyu Lim, Bucheon-si (KR); Tae Hyuck Kim, Asan-si (KR)

(73) Assignees: Hyundai Motor Company, Seoul (KR); Kia Corporation, Seoul (KR)

(21) Appl. No.: 17/728,410

(22) Filed: Apr. 25, 2022

(30) Foreign Application Priority Data
Jul. 23, 2021 (KR) 10-2021-0097325

(51) Int. Cl. H01M 10/48; H01M 50/505

(52) U.S. Cl. CPC H01M 10/486; H01M 50/505

(57) ABSTRACT

A battery module includes a plurality of stacked battery cells, a temperature sensor configured to measure the temperature of the battery cells and be coupled to a wire connected to the outside of the battery module, an inner plate configured to be coupled to the outside of the plurality of stacked battery cells in a stacking direction of the plurality of battery cells to cover the side surfaces of the plurality of battery cells and having a mounting groove to mount the temperature sensor therein, an outer plate configured to be coupled to the outside of the inner plate to apply a surface pressure to the plurality of stacked battery cells, and a fixing part configured to protrude from the inner plate to fix the wire extending from the temperature sensor, in which the fixing part is disposed to avoid the outer plate.

### CROSS REFERENCE TO RELATED APPLICATION

The present application claims priority to Korean Patent Application No. 10-2021-0097325, filed Jul. 23, 2021, the entire contents of which is incorporated herein for all purposes by this reference.

### BACKGROUND

### Technical Field

The present disclosure relates to a battery module installed in an electric vehicle.

### Description of the Related Art

Recently, in accordance with the global trend of reducing carbon dioxide emissions, the demand for electric vehicles that generate driving power by driving a motor with electric energy stored in an energy storage device such as a battery instead of typical internal combustion engine vehicles that generate driving power through combustion of fossil fuels is increasing significantly.

The performance of an electric vehicle is highly dependent on the capacity and performance of a battery which corresponds to an energy storage device that stores electric energy provided to a driving motor.

A vehicle battery that stores electric energy supplied to a motor to generate the driving power of a vehicle not only must have excellent characteristics in terms of electricity, such as excellent charge and discharge performance and a long service life, but also should ensure a high mechanical performance level that is robust to harsh vehicle driving environments such as high temperature and high vibration.

In addition, it is advantageous for vehicle manufacturers to configure battery hardware in the form of a module having a standardized size or capacity so that it may be applied consistently to various vehicle types.

The foregoing is intended merely to aid in the understanding of the background of the present disclosure, and is not intended to mean that the present disclosure falls within the purview of the related art that is already known to those skilled in the art.

### SUMMARY

Accordingly, the present disclosure has been made keeping in mind the above problem occurring in the related art, and the present disclosure is intended to provide a battery module configured to include a fixing part protruding from an inner plate to fix a wire that connects a temperature sensor measuring the temperature of the battery cells and the outside to the battery module, so that the wire is fixed on the inner plate.

The battery module of the present disclosure may include: a plurality of stacked battery cells; a temperature sensor configured to measure a temperature of the plurality of stacked battery cells and be coupled to a wire connected to an outside of the battery module; an inner plate configured to be coupled to an outside of the plurality of stacked battery cells in a stacking direction of the plurality of stacked battery cells to cover side surfaces of the plurality of battery cells and having a mounting groove to allow the temperature sensor to be mounted therein; an outer plate configured to be coupled to an outside of the inner plate to apply a surface pressure to the plurality of stacked battery cells; and a fixing part configured to protrude from the inner plate to fix the wire extending from the temperature sensor, wherein the fixing part is disposed to avoid the outer plate.

The inner plate may include a protrusion part extending to the outside of the inner plate, and the outer plate may include a through-hole penetrated at a position corresponding to the protrusion part to allow the protrusion part to be inserted thereinto.

The fixing part may be a plurality of fixing parts disposed on the outside of the inner plate.

The temperature sensor may include an upper sensor and a lower sensor coupled to both end parts in a direction crossing a longitudinal direction of the inner plate, and the wire extending from the lower sensor may be fixed on the fixing part and may extend toward the upper sensor to be connected to the wire extending from the upper sensor.

The battery module may further include a connector configured to connect the wire extending from the lower sensor and the wire extending from the upper sensor to each other.

The battery module may further include a tape configured to surround and be bonded to an outside of the wire fixed on the fixing part.

The fixing part may be configured to extend outward from the inner plate and surround the wire to allow the wire to be inserted and fixed therein.

The fixing part may be configured to have a pair of protrusions protruding at an interval and the wire may be inserted and fixed between the pair of protrusions.

The inner plate may be made of an insulating material including a plastic, and the outer plate may be made of a metallic material to press the stacked battery cells.

The outer plate may include a temperature sensor cover part configured to cover a part of the temperature sensor and fix the temperature sensor coupled to the inner plate.

The battery cells may include electrodes disposed at both longitudinal end parts thereof, wherein the battery module may further include: a bus bar configured to cover and electrically connect the electrodes of the battery cells to each other; and an upper cover configured to cover an upper side of the battery cells in a direction that is perpendicular to the stacking direction of the plurality of battery cells.

Accordingly, the battery module of the present disclosure includes the fixing part protruding outward from the inner plate and disposed to avoid the outer plate and the wire extending from the temperature sensor is fixed on the inner plate, so that the wire may be fixed on the inner plate, thereby providing effects of increasing maintenance convenience of the wire and the temperature sensor and preventing the temperature sensor from being decoupled by an external shock or movement of a vehicle.

Moreover, a plurality of wires may be provided and arranged when a plurality of temperature sensors are disposed, thereby providing effects of preventing the plurality of wires from getting tangled and increasing convenience during maintenance.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a perspective view showing a battery module according to an embodiment of the present disclosure.

FIG. 2 is a perspective view showing stacked battery cells included in the battery module according to an embodiment of the present disclosure.

FIG. 3 is a side view showing the battery module according to an embodiment of the present disclosure.

FIG. 4 is a side view showing the state in which tape is attached to the fixing part of the battery module according to an embodiment of the present disclosure.

### DETAILED DESCRIPTION

In the following description, the structural or functional description specified to exemplary embodiments according to the concept of the present disclosure is intended to describe the exemplary embodiments, so it should be understood that the present disclosure may be variously embodied, without being limited to the exemplary embodiments.

Embodiments described herein may be changed in various ways and various shapes, so specific embodiments are shown in the drawings and will be described in detail in this specification. However, it should be understood that the exemplary embodiments according to the concept of the present disclosure are not limited to the embodiments which will be described hereinbelow with reference to the accompanying drawings, but all of modifications, equivalents, and substitutions are included in the scope and spirit of the disclosure.

It will be understood that, although the terms first and/or second, etc. may be used herein to describe various elements, these elements should not be limited by these terms. These terms are only used to distinguish one element, from another element. For instance, a first element discussed below could be termed a second element without departing from the teachings of the present disclosure. Similarly, the second element could also be termed the first element.

It is to be understood that when one element is referred to as being “connected to” or “coupled to” another element, it may be connected directly to or coupled directly to another element or be connected to or coupled to another element, having the other element intervening therebetween. On the other hand, it is to be understood that when one element is referred to as being “connected directly to” or “coupled directly to” another element, it may be connected to or coupled to another element without the other element intervening therebetween. Further, the terms used herein to describe a relationship between elements, that is, “between”, “directly between”, “adjacent” or “directly adjacent” should be construed in the same manner.

The terminology used herein is for the purpose of describing particular embodiments only and is not intended to limit the present disclosure. Singular forms are intended to include plural forms unless the context clearly indicates otherwise. It will be further understood that the terms “comprises” or “have” used in this specification, specify the presence of stated features, steps, operations, components, parts, or a combination thereof, but do not preclude the presence or addition of one or more other features, numerals, steps, operations, components, parts, or a combination thereof.

Unless otherwise defined, all terms including technical and scientific terms used herein have the same meaning as commonly understood by those skilled in the art to which the present disclosure belongs. It must be understood that the terms defined by the dictionary are identical with the meanings within the context of the related art, and they should not be ideally or excessively formally defined unless the context clearly dictates otherwise.

Hereinbelow, preferred embodiments of the present disclosure will be described in detail with reference to accompanying drawings. The same reference numerals will be used throughout the drawings to refer to the same or like elements or parts.

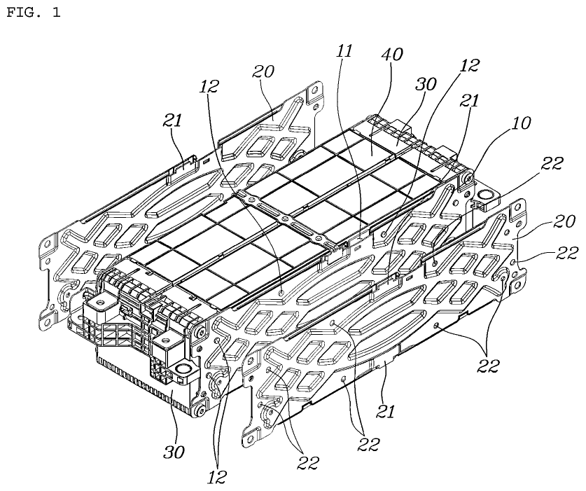

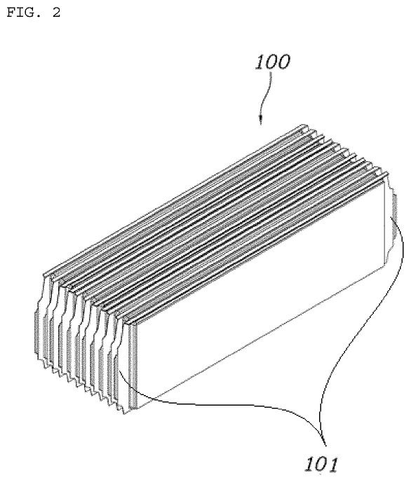

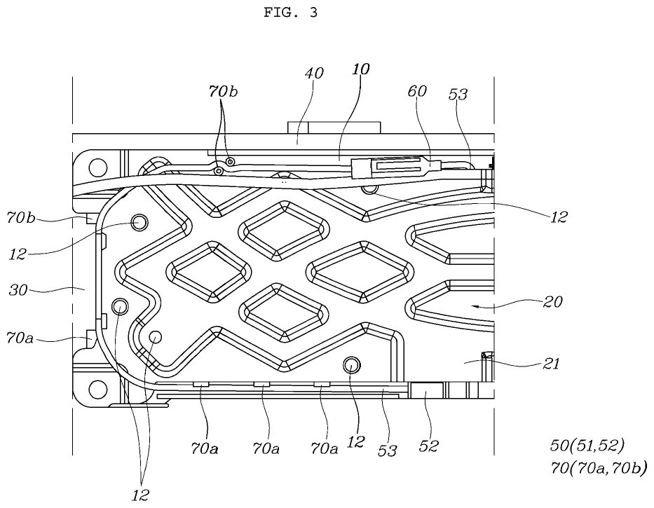

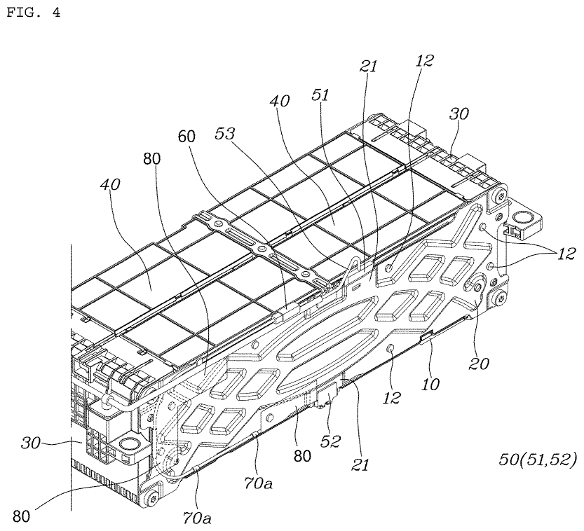

FIG. 1 is a perspective view showing a battery module according to an embodiment of the present disclosure, FIG. 2 is a perspective view showing stacked battery cells 100 included in the battery module according to an embodiment of the present disclosure, FIG. 3 is a side view showing the battery module according to an embodiment of the present disclosure, and FIG. 4 is a side view showing the state in which tape 80 is attached to a fixing part 70 of the battery module according to an embodiment of the present disclosure.

Referring to FIGS. 1 to 4, a preferred embodiment of the battery module according to the present disclosure will be described.

The battery module of the present disclosure may be a high voltage battery mounted in an electric vehicle and a module of the high voltage battery includes a plurality of battery cells to receive electricity.

Since the temperature of the plurality of battery cells 100 will be increased during operation and the battery cells 100 should be cooled when being heated higher than a predetermined temperature, a temperature sensor 50 may be mounted in the battery module, a wire 53 is connected to the temperature sensor 50, and the wire 53 extending to the outside is connected to a control module, and thus the operation of the battery module or a cooling module can be controlled.

The battery module according to the present disclosure may include: the plurality of stacked battery cells 100; the temperature sensor 50 configured to measure the temperature of the battery cells 100 and be coupled to the wire 53 that is connected to the outside; an inner plate 10 configured to be coupled to the outside of the plurality of stacked battery cells 100 in a stacking direction of the plurality of battery cells to cover the side surfaces of the plurality of battery cells 100 and having a mounting groove 11 formed to allow the temperature sensor 50 to be mounted therein; an outer plate 20 configured to be coupled to the outside of the inner plate 10 to apply a surface pressure to the plurality of stacked battery cells 100; and the fixing part 70 configured to protrude from the inner plate 10 to fix the wire 53 extending from the temperature sensor 50, in which the fixing part 70 may be disposed to avoid the outer plate 20.

The battery cells 100 may be formed in a planar shape extending in the longitudinal direction thereof and may be disposed to allow the surfaces of panels to be stacked with each other. To protect the outer surfaces of the battery cells, the inner plate 10 may be provided and disposed on the outside in the stacking direction of the plurality of stacked battery cells 100. The outer plate 20 may be disposed on the outer surface of the inner plate 10 to apply pressure in the stacking direction of the plurality of battery cells 100.

The temperature sensor 50 may be provided to measure the temperature of the outermost side of the battery cells 100 and the inner plate 10 may include a mounting groove 11, which has a groove corresponding to the shape of the temperature sensor 50, configured to allow the temperature sensor 50 to be mounted therein.

The temperature sensor 50 mounted in the inner plate 10 may be connected to the wire 53 extending outward to be connected to an external control module and such a wire 53 may be tangled or be disconnected from the temperature sensor 50 by an external shock or movement of a vehicle. To prevent this, the fixing part 70 configured to fix the wire 53 on the inner plate 10 may be provided.

The outer plate 20 may come in contact with and be coupled to the outside of the inner plate 10 and the fixing part 70 may be configured to protrude from a portion, in which the outer plate 20 does not come in contact with the inner plate (10), to the outside of the inner plate 10 to fix the wire 53 extending from the temperature sensor 50.

Therethrough, the present disclosure provides effects of allowing the wire 53 extending from the temperature sensor 50 to be coupled to the inner plate 10 to be fixed, preventing the wire 53 from being disconnected by an external shock or movement of a vehicle to allow the temperature sensor 50 to be normally operated, and fixing the wire 53 to increase convenience during maintenance of the temperature sensor 50.

The inner plate 10 may include a protrusion part 12 protruding outward and the outer plate 20 may include a through-hole 22 configured to allow the protrusion part 12 to be penetrated therethrough at a position corresponding to the protrusion part 12.

To couple the outer plate 20 to the inner plate 10 while avoiding the position of the fixing part 70 during coupling without overlapping with the fixing part 70, the outer plate 20 should be coupled to a predetermined position on the outer surface of the inner plate 10.

Accordingly, the protrusion part 12 extending outward is formed on the outer surface of the inner plate 10 and the through-hole 22 penetrated at the position corresponding to the protrusion part 12 is formed in the outer plate 20, thereby providing an effect of precisely coupling the outer plate 20 and the inner plate 10 at the predetermined position while inserting the protrusion part 12 into the through-hole 22 and avoiding the fixing part 70.

As shown in FIGS. 1 and 3, for example, the protrusion part 12 and the through-hole 22 are formed in plural, so that the position of the outer plate 20 may be precisely designated.

A plurality of fixing parts 70 may be disposed on the outside of the outer plate 20.

As shown in FIG. 3, the fixing part 70 is disposed on the outside of the outer plate 20 and protrudes from the inner plate 10 to be prevented from overlapping with the outer plate 20 and the plurality of fixing parts 70 fix a plurality of disposed and extending wires 53, so that the wires 53 may be fixed in the direction in which the fixing parts 70 are disposed, thereby being arranged.

Moreover, since the fixing part 70 is disposed on the outside of the outer plate 20, it may be prevented that the fixing part 70 is overlapped with the outer plate 20.

In the battery module according to the present disclosure, the battery cells 100 may include electrodes 101 disposed at both longitudinal end parts thereof. In this case, the battery module may further include a bus bar 30 configured to cover the electrodes 101 of the battery cells 100, and electrically connect the electrodes 101 to each other, and an upper cover 40 configured to cover the upper side of the battery cells 100 that is perpendicular to the stacking direction of the plurality of battery cells 100.

The bus bar 30 that electrically connects the electrodes 101 disposed at both the longitudinal end parts of the battery cells 100 to each other is connected to the control module to control operation of the battery cells 100 and the upper cover 40 provides an effect of preventing foreign matter from coming into the battery cells 100.

Moreover, since the lower part of the battery cells 100 is opened without having a cover disposed therein, the battery cells 100 may be cooled as external air is supplied thereto.

The temperature sensor 50 includes a pair of an upper sensor 51 and a lower sensor 52 connected in a direction crossing the longitudinal direction of the inner plate 10, and a wire 53 extending from the lower sensor 52 is fixed on the fixing part 70 to extend toward the upper sensor 51 and be connected to a wire 53 extending from the upper sensor 51.

A plurality of sensors may be coupled to the upper part of the inner plate 10 and the lower part of the inner plate 10, and the upper sensor 51 coupled to the upper part of the inner plate 10 and the lower sensor 52 coupled to the lower part of the inner plate 10 may measure the temperature of the battery cells 100, respectively, to calculate temperature information, and may transmit the temperature information of the battery cells 100 to the control module through the wire 53.

Since the upper cover 40 is disposed on the upper part of the battery cells 100 and is not disposed on the lower part of the same, the temperature measured in the upper sensor 51 differs from the temperature measured in the lower sensor 52, so that the control module may estimate the cooling amount of the battery cells 100 through a difference between the temperature measured in the upper sensor 51 and the temperature measured in the lower sensor 52.

The wire 53 extending from the lower sensor 52 may extend toward the wire 53 fixed on the fixing part 70 and extending from the upper sensor 51 to be connected to the wire 53 of the upper sensor 51.

Accordingly, the present disclosure provides effects of arranging the wire 53 and increasing work efficiency of a worker during maintenance.

The battery module according to the present disclosure may further include a connector 60 configured to connect the wire 53 extending from the lower sensor 52 and the wire 53 extending from the upper sensor 51.

The wire 53 extending from the upper sensor 51 is connected to the connector 60 and the wire 53 extending from the lower sensor 52 is also connected to the connector 60, so that each of the wires 53 connected to the connector 60 may be connected to the external control module.

Accordingly, since the wires 53 are connected by the connector 60, the present disclosure provides an effect of easily repairing the wire 53 when the wire 53 extending from the upper sensor 51 or the wire 53 extending from the lower sensor 52 is cut.

The battery module according to the present disclosure may further include a tape 80 configured to surround and be bonded to the outside of the wire 53 fixed on the fixing part 70.

Since the tape 80 is bonded to the outside of the wire 53 while being fixed on the wire 53 fixed on the fixing part 70, the wire 53 may be secondarily fixed on the inner plate 10.

Accordingly, as shown in FIG. 4, to prevent the outside of the wire 53 from separating from the fixing part 70, the present disclosure provides an effect of preventing the wire 53 from separating from the fixing part 70 by a shock applied to the fixing part 70 or movement of a vehicle.

The fixing part 70 may be configured to protrude outward from the inner plate 10 and surround the wire 53 to allow the wire 53 to be inserted and fixed therein.

As shown in FIG. 3, the fixing part 70, as a first embodiment 70a of the fixing part 70, may be configured to protrude from the outer surface of the inner plate 10 to surround the outer surface of the wire 53. The first embodiment 70a of the fixing part 70 may have an inlet formed to surround the outer surface of the wire 53 and allow the wire 53 to be inserted thereinto and the wire 53 may be inserted into the inlet of the fixing part 70 and be easily fixed by insertion-fitting.

The fixing part 70 may be formed by allowing a pair of protrusions to protrude at an interval and the wire 53 may be inserted and fixed between the pair of protrusions.

As shown in FIG. 3, the fixing part 70, as a second embodiment 70b of the fixing part 70, may be configured to allow the pair of protrusions to protrude from the outer surface of the inner plate 10 at a predetermined interval and the wire 53 may be inserted and fixed between the pair of protrusions.

The second embodiment 70b of the fixing part 70 has an advantage of being easily manufactured more than the first embodiment 70a.

The inner plate 10 may be made of an insulation material including a plastic and the outer plate 20 may be made of a metallic material to press the stacked battery cells 100.

The inner plate 10 may be made of an insulation material including a plastic and be manufactured by extrusion molding to insulate the stacked battery cells 100 from the outside and the outer plate 20 may be made of a metallic material to have a predetermined strength or more so as to press the stacked battery cells 100.

Moreover, since the inner plate 10 is made of a synthetic resin material such as a plastic, molding is facilitated, thereby providing an effect of easily molding and manufacturing the fixing part 70.

The outer plate 20 may include a temperature sensor cover part 21 configured to cover a part of the temperature sensor 50 and fix the temperature sensor 50 coupled to the inner plate 10.

To fix the temperature sensor 50 coupled to the inner plate 10, the outer plate 20 may include a temperature sensor cover part 21 configured to cover a part of the outside of the temperature sensor 50 coupled to the inner plate 10.

Accordingly, the present disclosure provides an effect of preventing the temperature sensor 50 coupled to the inner plate 10 from be decoupled by an external shock or movement of a vehicle.

Although the preferred embodiment of the present disclosure has been described for illustrative purposes, those skilled in the art will appreciate that various modifications, additions and substitutions are possible, without departing from the scope and spirit of the disclosure as disclosed in the accompanying claims.

What is claimed is:

1. A battery module comprising:
a plurality of stacked battery cells;
a temperature sensor configured to measure a temperature of the plurality of stacked battery cells and be coupled to a wire connected to an outside of the battery module;
an inner plate configured to be coupled to an outside of the plurality of stacked battery cells in a stacking direction of the plurality of stacked battery cells to cover side surfaces of the plurality of battery cells and having a mounting groove to allow the temperature sensor to be mounted therein;
an outer plate configured to be coupled to an outside of the inner plate to apply a surface pressure to the plurality of stacked battery cells; and
a fixing part configured to protrude from the inner plate to fix the wire extending from the temperature sensor, wherein the fixing part is disposed to avoid the outer plate.

2. The battery module of claim 1, wherein the inner plate comprises a protrusion part extending to the outside of the inner plate, and the outer plate comprises a through-hole penetrated at a position corresponding to the protrusion part to allow the protrusion part to be inserted thereinto.

3. The battery module of claim 1, wherein the fixing part comprises a plurality of fixing parts disposed on the outside of the inner plate.

4. The battery module of claim 3, wherein the temperature sensor comprises an upper sensor and a lower sensor coupled to both end parts in a direction crossing a longitudinal direction of the inner plate, and the wire extending from the lower sensor is fixed on the fixing part and extends toward the upper sensor to be connected to the wire extending from the upper sensor.

5. The battery module of claim 4, further comprising a connector configured to connect the wire extending from the lower sensor and the wire extending from the upper sensor to each other.

6. The battery module of claim 1, further comprising a tape configured to surround and be bonded to an outside of the wire fixed on the fixing part.

7. The battery module of claim 1, wherein the fixing part is configured to extend outward from the inner plate and to surround the wire to allow the wire to be inserted and fixed therein.

8. The battery module of claim 1, wherein the fixing part is configured to have a pair of protrusions protruding at an interval, and the wire is inserted and fixed between the pair of protrusions.

9. The battery module of claim 1, wherein the inner plate is made of an insulating material including a plastic, and the outer plate is made of a metallic material to press the plurality of stacked battery cells.

10. The battery module of claim 1, wherein the outer plate comprises a temperature sensor cover part configured to cover a part of the temperature sensor and to fix the temperature sensor coupled to the inner plate.

11. The battery module of claim 1, wherein the plurality of stacked battery cells comprise electrodes disposed at both longitudinal end parts thereof,
wherein the battery module further comprises:
a bus bar configured to cover and electrically connect the electrodes of the battery cells to each other; and
an upper cover configured to cover an upper side of the plurality of stacked battery cells in a direction perpendicular to the stacking direction of the plurality of battery cells.
